(19) United States
(12) Patent Application Publication
(10) Pub. No.: US 2014/0330662 A1
(43) Pub. Date: Nov. 6, 2014

(54) Polling Method for Auction, Raffle, or Lotto in a Social Network System

(71) Applicant: Sung Wan BAN, La Crescenta, CA (US)

(72) Inventor: Sung Wan BAN, La Crescenta, CA (US)

(21) Appl. No.: 13/888,048

(22) Filed: May 6, 2013

(51) Int. Cl. G06Q 30/08; G06Q 50/00

(52) U.S. Cl. CPC G06Q 30/08; G06Q 50/01
USPC 705/26.3

(57) ABSTRACT

A pooling method includes steps of providing each user of the social network system with bidding money, providing with bidding tickets; forming a bidding team of a maximum number of members among the plurality of users, and each member's entering the auction room by satisfying the auction-room-entrance condition and participating the bidding session as the bidding team by satisfying the auction-entrance condition. If any one or more members of the bidding team win the auction satisfying a predetermined winning condition, all the members of the bidding team are awarded with the target item and their BM, the BT, the BM+BT, or their combinations are nullified, which are used in the bidding session. If losing the auction, their BM, the BT, the BM+BT or their combinations of each member of the bidding team are nullified or refunded partially or entirely.

### BACKGROUND OF THE INVENTION

The present invention relates to a pooling method for an auction, lotto, or raffle in a social network system. More particularly, this invention relates to a pooling method for an auction or a raffle in a social network system by building a bidding team in the social network system, in which the bidding team can be formed and participate the auction in various ways in their social network for an auction bid or a raffle contest.

There are a number of inventions for the pooling method for an auction bid or a raffle contest, which permits individual bidders to form a bidding team during a bidding session. Some methods even suggest an auction held in an on-line network. However, recent rapid development of social network systems is changing the landscape for everything from how to interact with people, to how to place an advertisement, to how to do business. But, methods for holding an auction or a raffle contest are still limited to the traditional way and fail to utilize the potential that exists in the social network systems.

Accordingly, a need for an auction bidding or raffling method in a social network system has been present for a long time considering the expansive demands in everyday life. This invention is directed to solve these problems and satisfy a long-felt need.

### SUMMARY OF THE INVENTION

The present invention presents a pooling method for an auction bid or a raffle contest in a social network system that utilizes people's interaction and businesses' marketing strategies for advertisements in a social network system.

Specifically, the present invention provides an online bidding social networking system which utilizes online bidding money that can be given and received amongst members within a participant's network. Bidding content is effectively and quickly communicated within new and existing network connections, and it is through the cooperation of those within a network that brings about a successful bid.

By forming a bidding team and belonging to a potentially successful bidder, in the case of when the bidder wins the bid, the members of the bidding team receive compensations.

Thus, an object of the invention is to provide a pooling method for an auction, raffle, or lotto in a social network system by building a bidding team in the social network system.

An aspect of the invention provide a pooling method for auction, performed by a computer network for a social network system.

The pooling method comprises steps of: providing each of a plurality of users of the social network system with bidding money (BM); providing each of the plurality of users with bidding tickets (BT), wherein the BT entitles its holder to enter an auction room for a target item of a bidding session; forming a bidding team of a maximum number of members among the plurality of users, each of which having individual BM, BT, and BM+BT for satisfying an auction-room-entrance condition and an auction-entrance condition of the bidding session, wherein the maximum number of members depends on the target item; each member's entering the auction room by satisfying the auction-room-entrance condition and participating the bidding session as the bidding team by satisfying the auction-entrance condition; if any one or more members of the bidding team win the auction satisfying a predetermined winning condition, awarding all the members of the bidding team with the target item and nullifying the BM, the BT, the BM+BT, or their combinations of each member of the bidding team, which are used in the bidding session; and if losing the auction, nullifying the BM, the BT, the BM+BT or their combinations of each member of the bidding team, or refunding partially or entirely the BM, the BT, the BM+BT or their combinations of each member of the bidding team.

The target item may comprise target sub-items, and the number of target sub-items may be same as or larger than the maximum number of the bidding team members. Each member is awarded with one target sub-items.

The auction-room-entrance condition may be to pay a predetermined amount of BM, BT, or BM+BT.

The auction room may provide more than one bidding sessions.

On entering the auction room, each member of the bidding team may participate two or more bidding sessions.

The auction-room-entrance condition may be a free entrance. After entering the auction room for free, the user may participate a bidding session by satisfying the auction-entrance condition, that, by paying with BM or BT. The user in the bidding session may bid with bidding in BMs. In certain embodiments, the auction-entrance condition may be also free.

The bidding session may allow an individual user or any bidding team with two or less than the maximum number of members to enter the auction room.

Each of the individual user or the members of the bidding team may pay one or more BTs for the auction-entrance condition and pays one or more BMs for bidding with a bidding number.

The bidding session may allow the bidding team with the maximum number of members only to enter the auction room.

Each of the members of the bidding team may pay one or more BTs for the auction-entrance condition and pay nothing or one or more BMs for bidding with a bidding number.

The winning condition may be to bid a closest bidding to a target price suggested by the bidding session or a highest bidding above a price of the target item. Each of the users may allowed to bid lower than the target price, higher than the target price, or freely.

If more than one bidders bid a same bidding, then all the bidders of the same bidding may lose the auction.

The pooling method may further comprise steps for: purchasing one or more avatars with the BM, BT, or BM+BT and transferring some of BM, BT, or BM+BT of the user to each of the one or more avatars; and forming the bidding team with the purchased avatars.

The pooling method may further comprise a step for a first user's backing up a second user or a bidding team.

In such a case, if the second user or the bidding team wins the auction, the first user may be awarded with a predetermined BM, BT, BM+BT.

Some of the BM, BT, or BM+BT may be transferred from a third user to a fourth user.

The BM, BT, or BM+BT may be awarded to the user for activities in the social network system or in the Internet.

The activities may comprise watching or re-watching an advertisement, using the Internet above a predetermined amount, using the social network system, on-line shopping, using mobile communication, Internet chatting, mobile texting, downloading and executing applications, clicking an advertisement email, visiting a website, sharing or posting contents from a given website, playing Internet or mobile games, using given contents, watching movies or dramas, responding to Internet or mobile survey, using credit cards, and scanning barcode or QRC and visiting related website.

The BM, BT, or BM+BT of the members 10 of the bidding team 30 may be added so as to form a team BM, a team BT, or a team BM+BT, and wherein the team BM, the team BT, or the team BM+BT works like the individual BM, BT, or BM+BT.

Another aspect of the invention provides a pooling method for lotto, performed by a computer network for a social network system.

The pooling system comprise steps of: providing each of a plurality of users of the social network system with bidding money (BM); providing each of the plurality of users with bidding tickets (BT); forming a bidding team of a maximum number of members among the plurality of users, each of which having individual BM, BT, and BM+BT; each member's participating a lotto-playing session as the bidding team by satisfying the lotto-entrance condition and bidding with BM, BT, and BM+BT one or more times, wherein the lotto-entrance condition is to pay in BM or BT; and if any one or more members of the bidding team win the lotto satisfying a predetermined winning condition, awarding all the members of the bidding team with the lotto prize according their percentage of number of biddings, nullifying the paid BT, and nullifying or refunding partially or entirely the paid BM.

The advantages of the present invention are: (1) the present invention utilizes the potential of social networking system for a place for an auction, raffle, or lotto; (2) members of a social network system are more motivated to participate in an auction as a bidding team; and (3) the present invention gives companies an opportunity to market their products through advertisements and sell their goods in social networking systems.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will be better understood with reference to the accompanying drawings, wherein:

FIG. 1 is a flow chart showing a bidding procedure according to an embodiment of the invention;

FIG. 2 is a partial flow chart showing a step of forming a bidding team with avatars according to another embodiment of the invention;

FIG. 3 is a schematic diagram showing users, team, auction room, and bidding sessions according to still another embodiment of the invention;

FIG. 4 is a schematic diagram showing a user's participating a bidding session in an auction room according to still another embodiment of the invention;

FIG. 5 is a schematic diagram showing a bidding distribution according to still another embodiment of the invention;

FIG. 6 is a schematic diagram showing a team formed by three users according to still another embodiment of the invention;

FIG. 7 is a schematic diagram showing a team formed by a user with two avatars according to still another embodiment of the invention;

FIG. 8 is a schematic diagram showing a bidding team with a bidding session having a target item according to still another embodiment of the invention;

FIG. 9 is a schematic diagram showing a social network system formed by a computer network according to an embodiment of the invention;

FIG. 10 is a schematic diagram showing an application of a bidding procedure according to an embodiment of the invention and how the advertisement works;

FIG. 11 is a screen capture of a mobile communication device showing a playing of lotto;

FIG. 12 is mobile communication devices showing a locked status with two possible participating of an advertisement according to an embodiment of the invention;

FIG. 13 is a mobile communication device showing various possible participating of an advertisement according to another embodiment of the invention;

FIG. 14 is a mobile communication device showing adopting of an advertisement according to another embodiment of the invention;

FIG. 15 is a mobile communication device showing adopting of another advertisement according to still another embodiment of the invention;

FIG. 16 is a smart TV device showing adopting of an advertisement according to an embodiment of the invention;

FIG. 17 is a smart TV device showing adopting of another advertisement according to another embodiment of the invention;

FIG. 18 is a schematic diagram showing a bidding session for fixed threesomes; and

FIG. 19 is a schematic diagram showing a bidding session for mixed threesomes.

### DETAILED DESCRIPTION EMBODIMENTS OF THE INVENTION

The U.S. patent application Ser. No. 13/083,902 is incorporated by reference into this disclosure as if fully set forth herein.

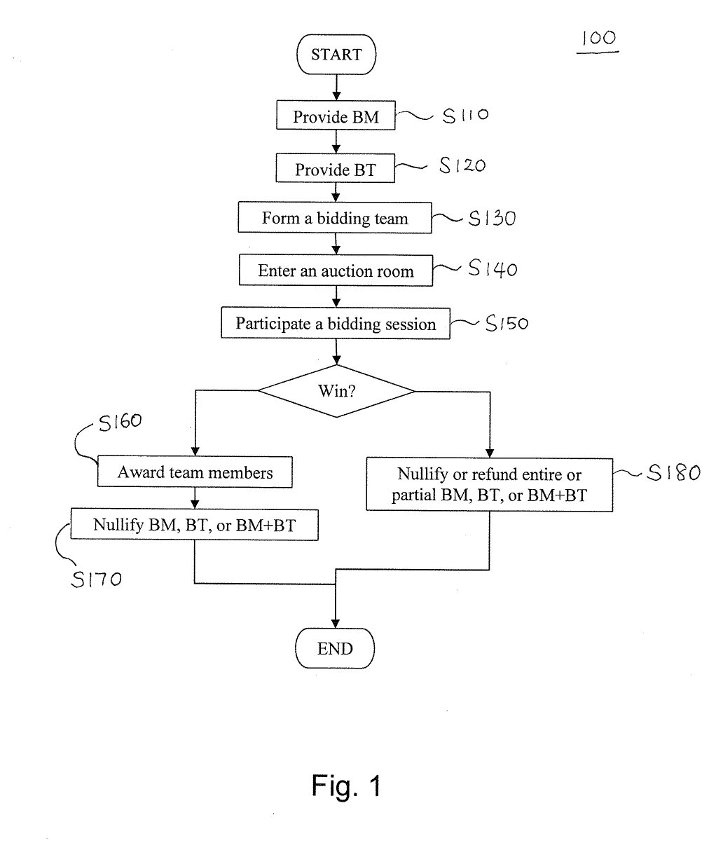

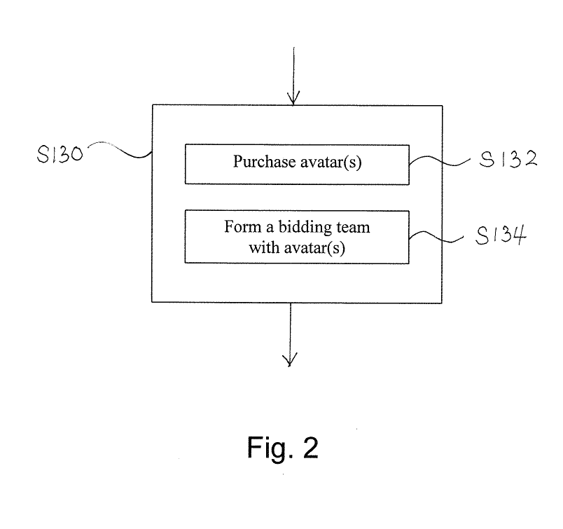

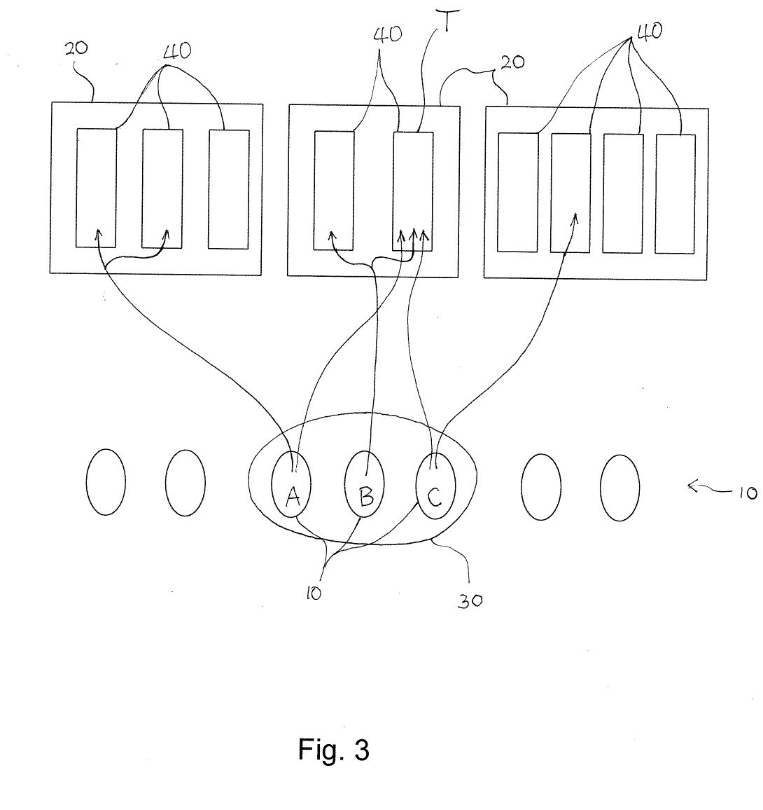

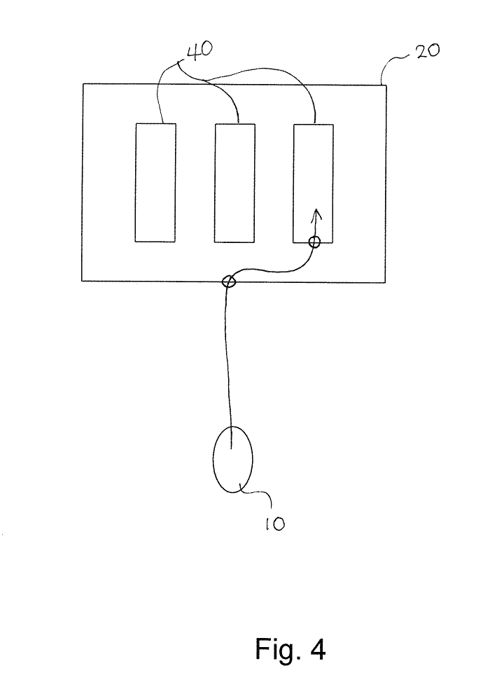

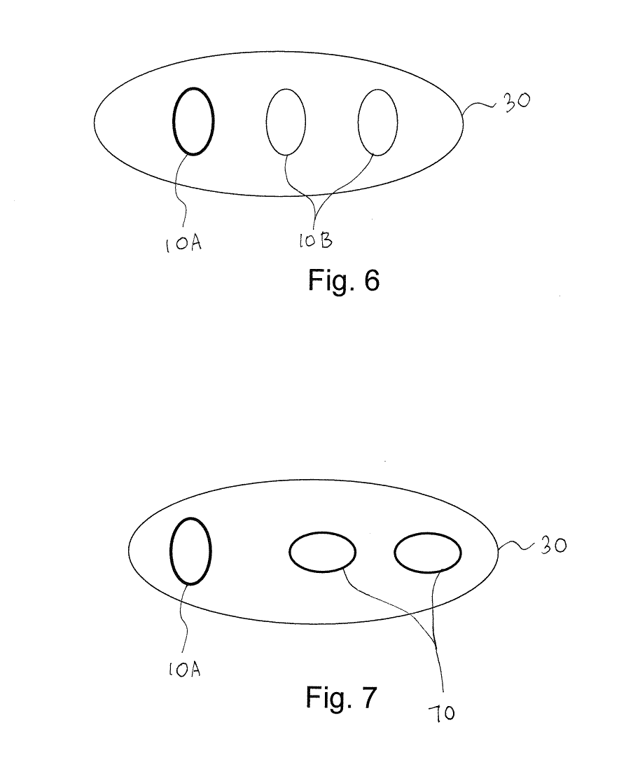

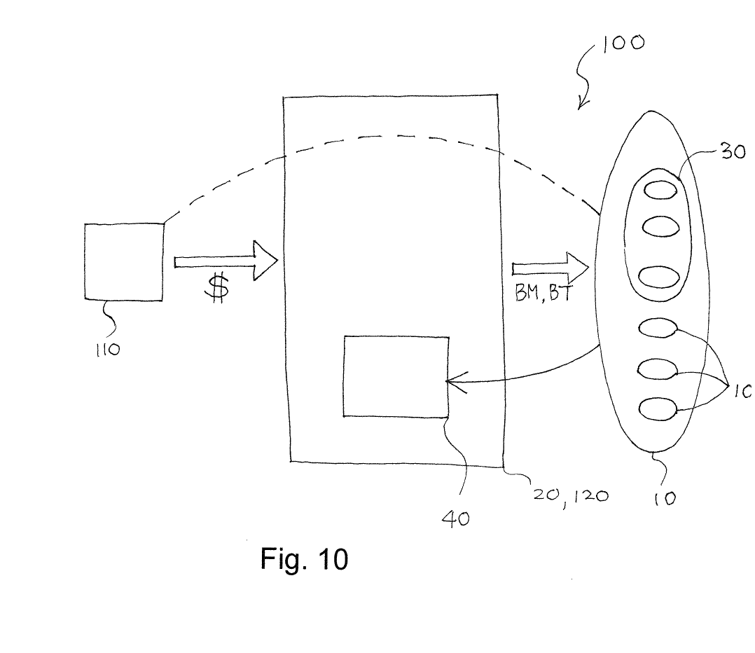

FIGS. 1 and 2 show flow charts showing a bidding procedure according to an embodiment of the invention. FIGS. 3-8 show schematic diagrams showing various scenes in the bidding procedure according to embodiments of the invention. FIG. 10 shows an application of a bidding procedure according to an embodiment of the invention and how the advertisement works.

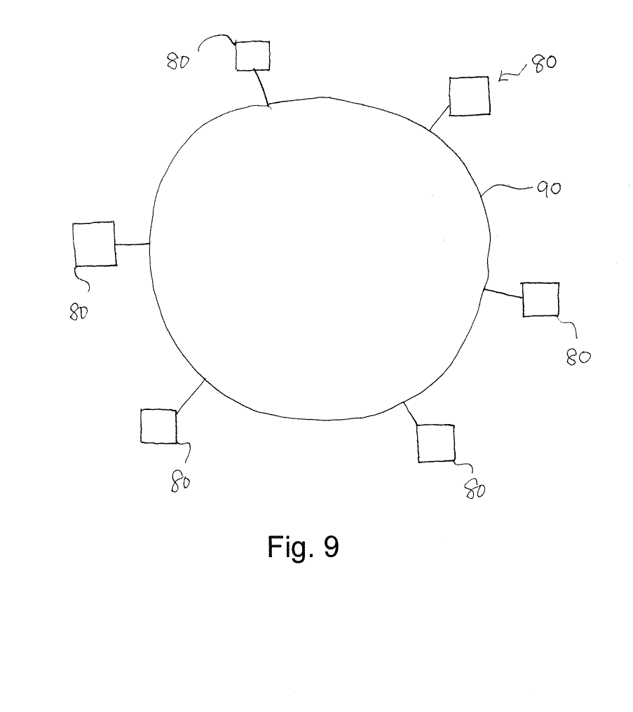

An aspect of the invention provide a pooling method 100 for auction, performed by a computer network 80 for a social network system 90 as shown in FIG. 9. The social network system 90 may be thought to be formed by the computer network 80. Each of the boxes in FIG. 9 may be considered a server or a personal computer operated by a user.

The pooling method 100 comprises steps of: providing each of a plurality of users 10 of the social network system 90 with bidding money (BM) (S110); providing each of the plurality of users 10 with bidding tickets (BT), wherein the BT entitles its holder to enter an auction room 20 for a target item 42 of a bidding session (S120); forming a bidding team 30 of a maximum number of members among the plurality of users 10, each of which having individual BM, BT, and BM+BT for satisfying an auction-room-entrance condition and an auction-entrance condition of the bidding session, wherein the maximum number of members depends on the target item 42 (S130); each member's entering the auction room 20 by satisfying the auction-room-entrance condition (S140) and participating the bidding session 40 as the bidding team 30 by satisfying the auction-entrance condition (S150); if any one or more members 10 of the bidding team 30 win the auction satisfying a predetermined winning condition, awarding all the members 10 of the bidding team 30 with the target item 42 (S160) and nullifying the BM, the BT, the BM+BT, or their combinations of each member 10 of the bidding team 30, which are used in the bidding session (S170); and if losing the auction, nullifying the BM, the BT, the BM+BT or their combinations of each member 10 of the bidding team 30, or refunding partially or entirely the BM, the BT, the BM+BT or their combinations of each member 10 of the bidding team 30 (S180) as shown in FIG. 1.

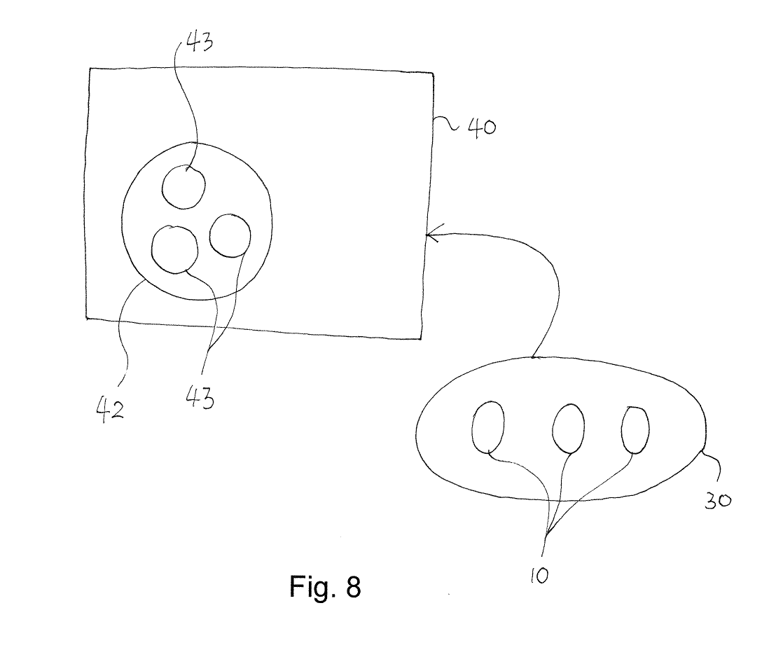

The target item 42 may comprise target sub-items 43, and the number of target sub-items 43 may be same as or larger than the maximum number of the bidding team members 10 as shown in FIG. 8.

If the number of members 10 of the bidding team 30 is same as the number of target sub-items 43 each of the members 10 is awarded with a single target sub-items 43.

However, if the number of members 10 of the bidding team 30 is smaller than the number of target sub-items 43 each of the members 10 is awarded with still just one target sub-item 43. The remaining target sub-items 43 is going to be returned to the advertising company 120.

The auction-room-entrance condition may be to pay a predetermined amount of BM, BT, or BM+BT.

The auction room 20 may provide more than one bidding sessions.

On entering the auction room 20, each member of the bidding team 30 may participate two or more bidding sessions 40 as shown in FIG. 3.

The auction-room-entrance condition may be a free entrance. After entering the auction room 20 for free, the user 10 may participate a bidding session 40 by satisfying the auction-entrance condition, that, by paying with BM or BT. The user in the bidding session 40 may bid with bidding in BMs. In certain embodiments, the auction-entrance condition may be also free.

The bidding session 40 may allow an individual user 10 or any bidding team 30 with two or less than the maximum number of members to enter the auction room 20.

Each of the individual user 10 or the members 10 of the bidding team 30 may pay one or more BTs for the auction-entrance condition and pays one or more BMs for bidding with a bidding number.

The bidding session 40 may allow the bidding team 30 with the maximum number of members only to enter the auction room 20.

Each of the members 10 of the bidding team 30 may pay one or more BTs for the auction-entrance condition and pay nothing or one or more BMs for bidding with a bidding number.

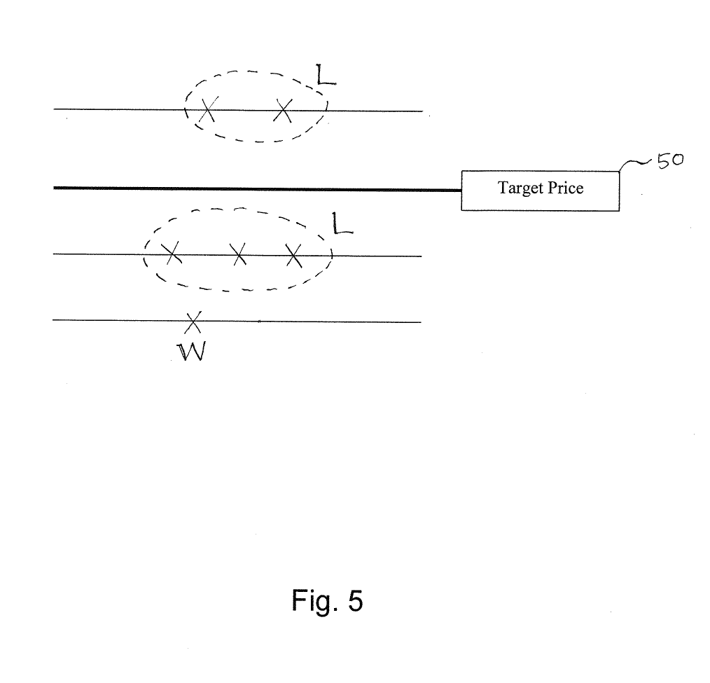

The winning condition may be to bid a closest bidding to a target price 50 suggested by the bidding session 40 or a highest bidding above a price of the target item. Each of the users 10 may allowed to bid lower than the target price, higher than the target price, or freely. Referring to FIG. 5, the users 10 may be allowed to the top side or bottom side of the target price 50, or anywhere freely around the target price 50.

If more than one bidders (X) bid a same bidding, then all the bidders of the same bidding may lose the auction as shown in FIG. 5. The bidders enclosed by dashed lines are made to lose.

The pooling method 100 may further comprise steps for: purchasing one or more avatars 70 with the BM, BT, or BM+BT and transferring some of BM, BT, or BM+BT of the user to each of the one or more avatars 70 (S132); and forming the bidding team with the purchased avatars 70 (S134) as shown in FIG. 2.

The pooling method 100 may further comprise a step for a first user's backing up a second user or a bidding team with BM, BT, or BM+BT.

If the second user or the bidding team wins the auction, the first user may be awarded with a predetermined BM, BT, BM+BT.

Some of the BM, BT, or BM+BT may be transferred from a third user to a fourth user.

The BM, BT, or BM+BT may be awarded to the user for activities in the social network system or in the Internet.

The activities may comprise watching or re-watching an advertisement, using the Internet above a predetermined amount, using the social network system, on-line shopping, using mobile communication, Internet chatting, mobile texting, downloading and executing applications, clicking an advertisement email, visiting a website, sharing or posting contents from a given website, playing Internet or mobile games, using given contents, watching movies or dramas, responding to Internet or mobile survey, using credit cards, and scanning barcode or QRC and visiting related website.

The BM, BT, or BM+BT of the members of the bidding team may be added so as to form a team BM, a team BT, or a team BM+BT, and wherein the team BM, the team BT, or the team BM+BT works like the individual BM, BT, or BM+BT.

Another aspect of the invention provides a pooling method for lotto, performed by a computer network for a social network system. The steps are almost same as those of the pooling method for auction described in the above. Therefore, a separate flow chart is omitted here.

The pooling method comprise steps of: providing each of a plurality of users of the social network system with bidding money (BM); providing each of the plurality of users with bidding tickets (BT); forming a bidding team of a maximum number of members among the plurality of users, each of which having individual BM, BT, and BM+BT; each member's participating a lotto-playing session as the bidding team by satisfying the lotto-entrance condition and bidding with BM, BT, and BM+BT one or more times, wherein the lotto-entrance condition is to pay in BM or BT; and if any one or more members of the bidding team win the lotto satisfying a predetermined winning condition, awarding all the members of the bidding team with the lotto prize according their percentage of number of biddings, nullifying the paid BT, and nullifying or refunding partially or entirely the paid BM.

The pooling method for auction or lotto can be a part of a big picture of advertisement in the social network system as shown in FIG. 10.

In the illustrated embodiment, an advertiser or a sponsor of advertisement 110 employs an advertising company 120 by giving a given amount of money. Then, the advertising company 120 distributes to the users 10 or teams 30 BT and BM corresponding to the given amount of money received from the sponsor 110 through a plurality of different ways to facilitate the users 10 to watch the advertisements of the sponsor 110. The users 10 watch the advertisement, earn their BM or BT, and then participate an auction or raffle or lotto according to the present invention to win a target item 42. The target item 42 is cheaper than the given amount of money that the advertising company 120 received from the sponsor 110. The advertising company 120 provides the auction room 20 to the users 10 so as to participate the auction and win the target item 42 using their own BM and BT. Through the process, the sponsor 110 is connected with the users 10 exchanging the advertisement and the target item 42 with the advertising company 120 or the auction room 20 according to the invention.

The bidding money BM may be money or point corresponding to money that is needed to make a bid. The user 10 may bid with the BM as if with a real money. The advertising company 120 may distribute some amount of BM according to the predetermined activities of the users 10 in the social network system or on the Internet.

The bidding ticket BT may money or point corresponding to money that is needed to enter an auction room 20.

The BM and BT can be combined to to BM+BT, which can be used in entering the auction room 20 or the bidding session 40.

The BM or BT can have a unit similar to the real money with some fixed ratio. For example, one dollar may be converted to $1000 in the cyber money (BM+BT). The ratio can be adjusted arbitrarily by the advertising company 120 or the auction room 20.

The BM or BT can be awarded to the users 10 through a predetermined app or application downloaded from a server of the advertising company 20 to a personal device of the user 10 such as personal Internet device, a mobile communication device, a smart TV, a smart car (unmanned car), etc.

Such predetermined app or application can monitor the advertisement-related activities of the user 10 in the social network system or Internet in general and award an appropriate amount of BM or BT to the user 10.

The activities which earns the user the BM or BT can include the followings: watching an advertisement from the social network system or a given website; performing an Internet search in a specific search website or search engine; using the Internet longer than a predetermined length of time or data amount; using the social network services (posting, likes, follows, followers, shares, etc.); on-line shopping; using the mobile communication (phone, internet, text, etc.); Internet chatting; using a mobile texting; downloading or executing other predetermined applications; watching the advertisement more than one time; clicking an advertisement emails; visiting websites of the sponsor 110; posting or sharing the advertisement pictures, video, streaming in the social network; other people's watching or sharing of the advertisement that one posted or shared (if I posted or shared, my friends, the other people, and I are awarded according to a predetermined ratio); playing predetermined Internet games, mobile games, and smart TV games; using predetermined contents such as movies, dramas, and other services; participating an Internet or mobile surveys; using credit cards, point cards, ATM cards, GAS cards, etc. that are related to mobile or smart TV wallet.

For the above activities, the BM or BT can be awarded flexibly according to their amounts of use.

Some of the bidding sessions can be attended by a single user or a bidding team made up with two or more users. The maximum number of the members in the bidding team may depend on the number of target sub-items. For example, the target item includes three iPhones, then the bidding team may have maximum three members, such that it is easy to divide the target item among the members.

A user or a bidding team can have other users back up his/her/its BM or BT with their BM or BT.

A user or a bidding team can participate two or more bidding sessions in two or more different auction rooms.

The auction-room-entrance condition or the auction-entrance condition can be determined arbitrarily by the advertising company 120 or the auction room 20. Free entrance may be enabled for some auction rooms or bidding sessions.

The BM, BT, or BM+BT used in the bidding may be nullified or refunded partially or entirely according to whether the user or team is on the winning side or not, of course, following the policy of the advertising company 120.

In playing lotto, a user or team can purchase the lottos using the BM or BT earned from the activities in the social network and write in numbers of their own choice. Each of the writing in of the numbers of their own choice may require a given amount of ET or BM+BT, which is nullified after writing in. If the user used the BM for writing in numbers may be nullified or refunded partially or entirely after winning.

For an example, the BM of amount equal to the sum of the numbers the user wrote in may be may be nullified or refunded partially or entirely after winning.

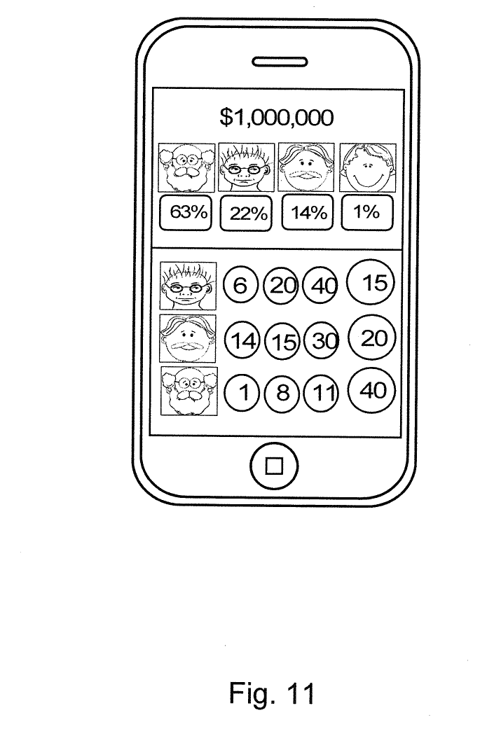

When a team wins the lotto, the prize can be awarded to the members of the team according to their number of playings or biddings as shown in FIG. 11. In the illustrated embodiment, the lotto is attended by a team having four members with their attending or bidding percentages displayed under their pictures, and each of the team members has chosen 4 numbers using their BM, BT, or BM+BT. After winning the lotto, the team member's BM, BT, or BM+BT corresponding to at least (from FIG. 11) 46+20+40+15 from the second user (22%), 14+15+30+20 from the third user (14%), and 1+8+11+40 from the first user (63%) may be nullified or refunded partially or entirely.

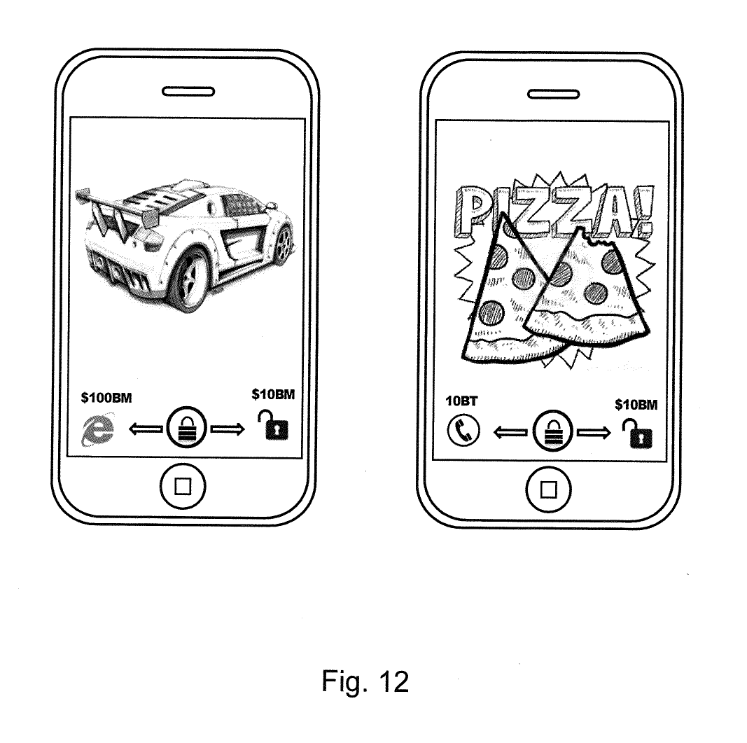

FIGS. 12-17 show various ways for a user 10 to earn BM or BTs through the activities.

FIG. 12 is mobile communication devices showing a locked status with two possible participating of an advertisement according to an embodiment of the invention.

Both mobile communication devices are about to be operated to unlock. Initially, the user downloads the advertisement app from the sponsor winning some BM or BT already. The ad app gives the user two choices: dragging the lock to the right so as to unlock the device still winning $10BM (watched the background ad information already) and dragging the lock to the left so as to access the website of the sponsor winning $100BM or $10BT, for example.

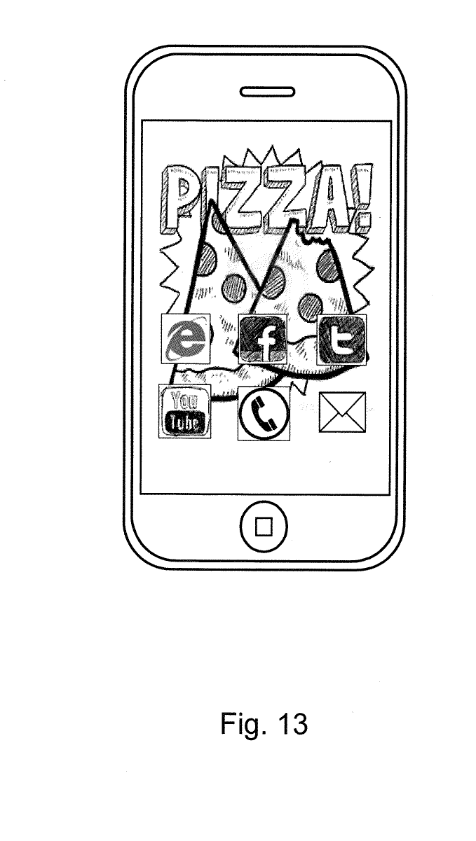

FIG. 13 is a mobile communication device showing an ad app providing various possible participating of an advertisement according to another embodiment of the invention.

The user can touch corresponding buttons to access and participate the advertisement in various social network services such as Facebook® or Twitter® or YouTube®. Or the user can email or call the sponsor. In this case, the user can call the pizza place to order right away.

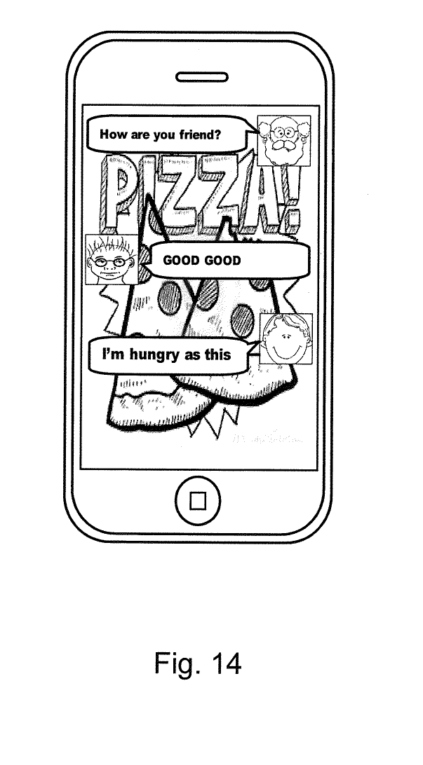

FIG. 14 is a mobile communication device showing adopting of an advertisement according to another embodiment of the invention.

The ad app in this case provides an advertising background to a social network service winning or earning some BM or BT for a given condition such as usage of time, etc.

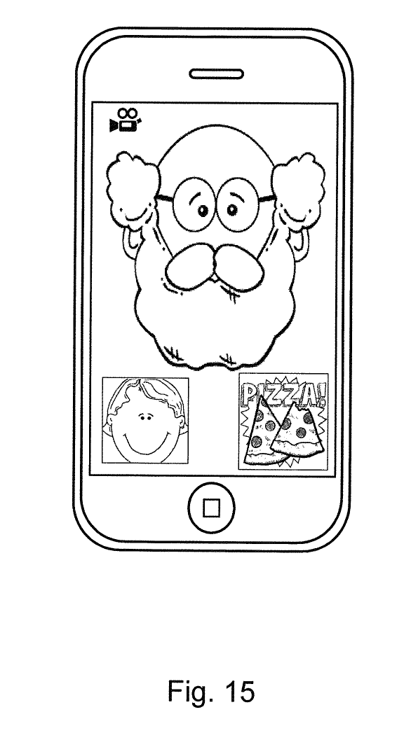

FIG. 15 is a mobile communication device showing adopting of another advertisement according to still another embodiment of the invention.

The ad app in this case provides an advertising image or clickable button for the sponsor. While he or she uses a function of the mobile communication device, the user can look at or respond to the ad.

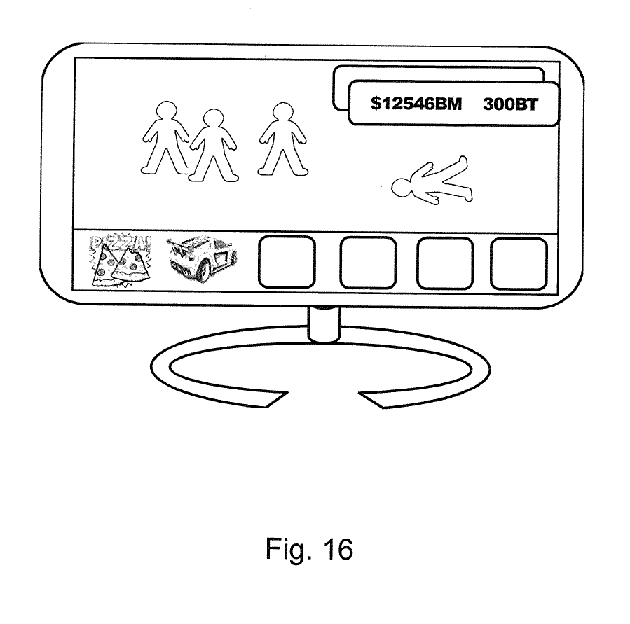

FIG. 16 is a smart TV device showing adopting of an advertisement according to an embodiment of the invention.

The ad app may be installed and operated in a smart TV. Due to its wide screen, the ad forms and quantities may be much more affluent than the mobile device. In the illustrated embodiment, the lower edge of the screen can be crowded with ad apps. The user may earn BM or BT for installing the ad apps or responding to them by clicking them with cursor, for example.

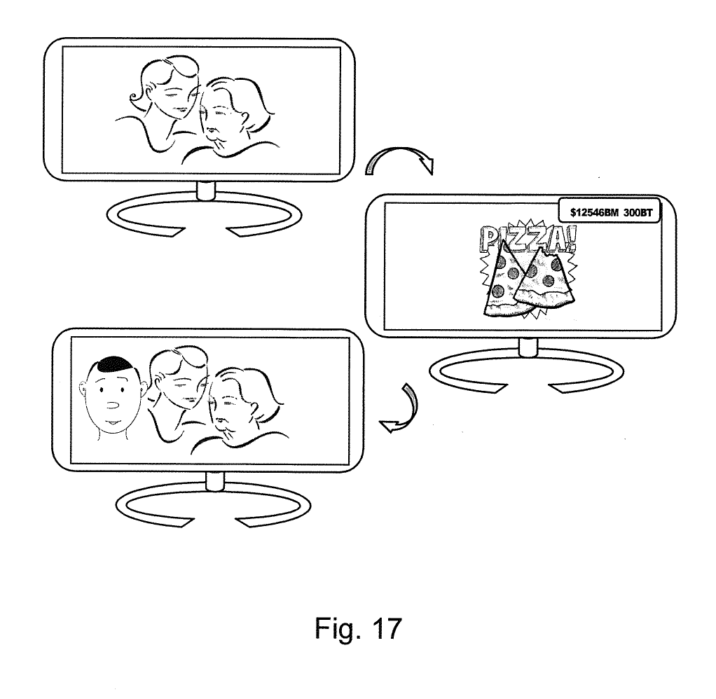

FIG. 17 is a smart TV device showing adopting of another advertisement according to another embodiment of the invention.

The ad app in this case can be inserted in the smart TV programs.

Still another aspect of the invention provides a raffle system, which the bidding teams participate, using the same raffle method disclosed in the incorporated U.S. patent application Ser. No. 13/083,902 by Applicant.

Referring to FIG. 3, the three users A, B, C form a bidding team 30. In the illustrated embodiment, the bidding team 30 is playing as a team just for the bidding session T. For the other bidding sessions 40 in which not all of the three members A, B, C participate, they are not forming a bidding team. Of course, they can participate in the other one or more bidding sessions 40 at the same time.

Still in the illustrated embodiment, for an example, the user A can bid to the bidding session T ten (10) times, the user B three (3) times, and the user C one (1) time. If the bidding team 30 wins the bidding session T, each of them is going to awarded with one target sub-item. In contrast, if the same bidding team 30 wins a lotto, then the users A, B, C are awarded with amount of prize money in the ratio of 10:3:1.

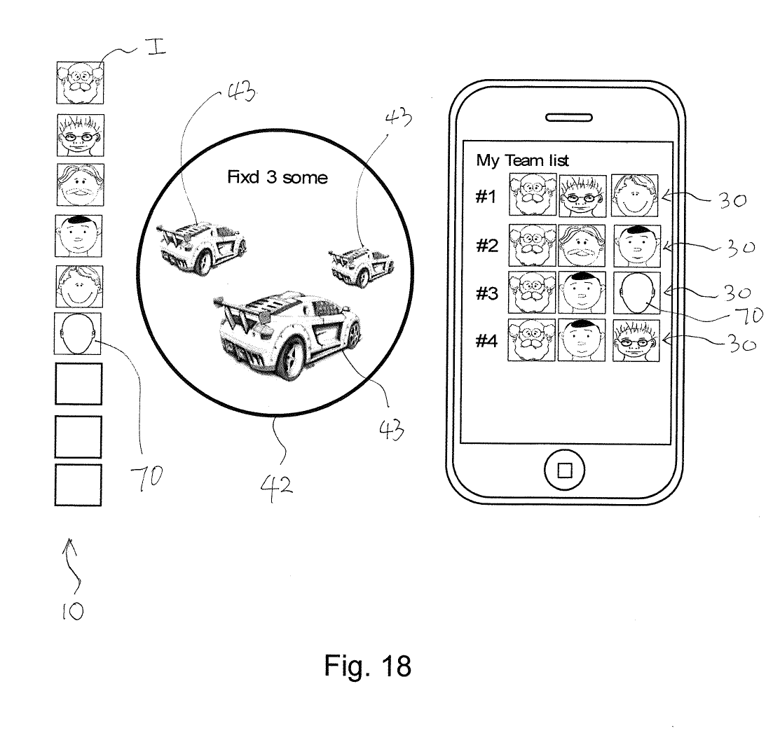

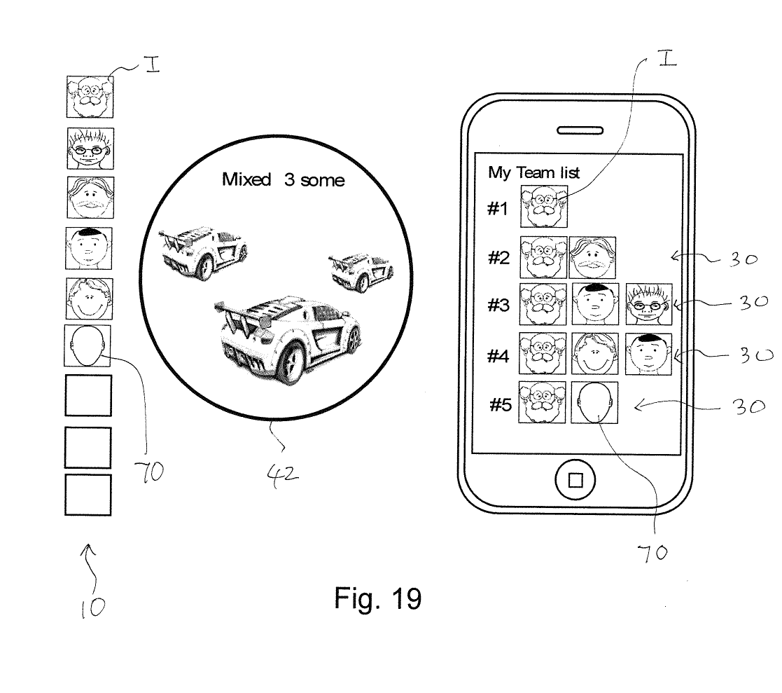

FIG. 18 is a schematic diagram showing a bidding session for fixed threesomes, and FIG. 19 is a schematic diagram showing a bidding session for mixed threesomes.

As discussed in the above, some bidding sessions are open to threesome teams only as in FIG. 18. Out of potential users 10, a specific user I can be a member of four different bidding teams #1, #2, #3, #4, each of which consists of three members. In that case, the target item 42 may consist three target sub-items 43, that is, three cars.

In FIG. 19, the bidding session 40 allows all kinds of participants up to a bidding team consisting of maximum three members because there are three target sub-items 43 in this illustrated case. The specific user I can participate the bidding session 40 alone, a twosome team 30, two threesome teams 30, and a twosome team 30 formed by his avatar 70 and himself. If the user I wins the bidding session 40 alone, he is awarded with one car. But, eventually the user I will have any car awarded to his avatar 70 if the avatar 70 wins it.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A pooling method for auction, performed by a computer network for a social network system, comprising steps of:
providing each of a plurality of users of the social network system with bidding money (BM);
providing each of the plurality of users with bidding tickets (BT), wherein the BT entitles its holder to enter an auction room for a target item of a bidding session;
forming a bidding team of a maximum number of members among the plurality of users, each of which having individual BM, BT, and BM+BT for satisfying an auction-room-entrance condition and an auction-entrance condition of the bidding session, wherein the maximum number of members depends on the target item;
each member's entering the auction room by satisfying the auction-room-entrance condition and participating the bidding session as the bidding team by satisfying the auction-entrance condition;
if any one or more members of the bidding team win the auction satisfying a predetermined winning condition, awarding all the members of the bidding team with the target item and nullifying the BM, the BT, the BM+BT, or their combinations of each member of the bidding team, which are used in the bidding session; and
if losing the auction, nullifying the BM, the BT, the BM+BT or their combinations of each member of the bidding team, or refunding partially or entirely the BM, the BT, the BM+BT or their combinations of each member of the bidding team.

2. The pooling method of claim 1, wherein the target item comprises target sub-items, wherein the number of target sub-items are same as or larger than the maximum number of the bidding team members, and wherein each member is awarded with one target sub-items.

3. The pooling method of claim 1, wherein the auction-room-entrance condition is to pay a predetermined amount of BM, BT, or BM+BT.

4. The pooling method of claim 1, wherein the auction room provides more than one bidding sessions.

5. The pooling method of claim 4, wherein on entering the auction room, each member of the bidding team participates two or more bidding sessions.

6. The pooling method of claim 3, wherein the auction-room-entrance condition is a free entrance.

7. The pooling method of claim 6, wherein the bidding session allows an individual user or any bidding team with two or less than the maximum number of members to enter the auction room.

8. The pooling method of claim 7, wherein each of the individual user or the members of the bidding team pays one or more BTs for the auction-entrance condition and pays one or more BMs for bidding with a bidding number.

9. The pooling method of claim 6, wherein the bidding session allows the bidding team with the maximum number of members only to enter the auction room.

10. The pooling method of claim 3, wherein each of the members of the bidding team pays one or more BTs for the auction-entrance condition and pays nothing or one or more BMs for bidding with a bidding number.

11. The pooling method of claim 1, wherein the winning condition is to bid a closest bidding to a target price suggested by the bidding session or a highest bidding above a price of the target item, wherein each of the users is allowed to bid lower than the target price, higher than the target price, or freely.

12. The pooling method of claim 11, wherein if more than one bidders bid a same bidding, then all the bidders of the same bidding lose the auction.

13. The pooling method of claim 1, further comprising steps for:
purchasing one or more avatars with the BM, BT, or BM+BT and transferring some of BM, BT, or BM+BT of the user to each of the one or more avatars; and
forming the bidding team with the purchased avatars.

14. The pooling method of claim 1, further comprising a step for a first user's backing up a second user or a bidding team.

15. The pooling method of claim 14, wherein if the second user or the bidding team wins the auction, the first user is awarded with a predetermined BM, BT, BM+BT.

16. The pooling method of claim 1, wherein some of the BM, BT, or BM+BT is transferable from a third user to a fourth user.

17. The pooling method of claim 1, wherein the BM, BT, or BM+BT is awarded to the user for activities in the social network system or in the Internet.

18. The pooling method of claim 17, wherein the activities comprise watching or re-watching an advertisement, using the Internet above a predetermined amount, using the social network system, on-line shopping, using mobile communication, Internet chatting, mobile texting, downloading and executing applications, clicking an advertisement email, visiting a website, sharing or posting contents from a given website, playing Internet or mobile games, using given contents, watching movies or dramas, responding to Internet or mobile survey, using credit cards, and scanning barcode or QRC and visiting related website.

19. The pooling method of claim 1, wherein the BM, BT, or BM+BT of the members of the bidding team are added so as to form a team BM, a team BT, or a team BM+BT, and wherein the team BM, the team BT, or the team BM+BT works like the individual BM, BT, or BM+BT.

20. A pooling method for lotto, performed by a computer network for a social network system, comprising steps of:
providing each of a plurality of users of the social network system with bidding money (BM);
providing each of the plurality of users with bidding tickets (BT);
forming a bidding team of a maximum number of members among the plurality of users, each of which having individual BM, BT, and BM+BT;
each member's participating a lotto-playing session as the bidding team by satisfying the lotto-entrance condition and bidding with BM, BT, and BM+BT one or more times, wherein the lotto-entrance condition is to pay in BM or BT;
if any one or more members of the bidding team win the lotto satisfying a predetermined winning condition, awarding all the members of the bidding team with a lotto prize according their percentage of number of biddings, nullifying the paid BT, and nullifying or refunding partially or entirely the paid BM.
